(19) United States
(12) Patent Application Publication
(10) Pub. No.: US 2014/0000061 A1
(43) Pub. Date: Jan. 2, 2014

(54) Window-Mounted Air Conditioner and General Appliance Support Handles

(71) Applicant: Douglas Waters, Gardner, MA (US)

(72) Inventor: Douglas Waters, Gardner, MA (US)

(21) Appl. No.: 13/537,235

(22) Filed: Jun. 29, 2012

(51) Int. Cl. B25G 1/00

(52) U.S. Cl. 16/110.1

(57) ABSTRACT

Disclosed is a handled appliance support for a window-mounted air conditioner unit, comprising a pair of U-shaped handles along the interior face of the appliance for providing a user with a means for obtaining improved purchase and control when handling, installing and removing an air conditioner unit. The handles comprise elongated vertical members affixed via a pair of horizontal members forming a pair of U-shape grips for which the user to grasp and support the unit from within the interior side of a window opening. The handles may be externally mounted, integrated into the interior face or alternatively be retrofitted onto an existing unit via a pair of elongated strap elements that surround the unit and support the handles in their working position.

### BACKGROUND OF THE INVENTION

1. Field of the Invention

The present invention relates to window-mounted air conditioner units. More specifically, the present invention pertains to an improved means of purchase on window unit air conditioners, wherein a pair of handles is provided along the interior structure thereof or connectable handles are attachable around the perimeter of the unit for improved grip, handling and control of the unit during installation and removal.

Window-mounted and through-wall mounted air conditioning units are packaged systems that allow cooling of a localized space or room within a dwelling. These devices operate using a phase-change refrigeration cycle that incorporates interior and exterior air for creating a cooled stream of air that is blown into the room interior space while hot air is exhausted. Unitary systems of this type generally sit within a window or wall opening and straddle the boundary between the exterior environment and the interior room requiring climate control. The interior room air is cooled as a fan blows the interior air over an evaporator coil, which cools the air as refrigerant is converted to all vapor from a liquid and vapor mixture within the coil. On the exterior side of the unit, air is heated as a second fan blows the air over a condenser, removing heat from the vaporized refrigerant within the condenser coils. During this process, heat is drawn from the interior room and discharged into the environment.

Window and wall-mounted air conditioner units are popular in homes that are absent of central air cooling, wherein several air conditioner units are generally installed throughout the home as a way to cool each room individually. It is common for these units to be placed within an open window, wherein the unit is secured against the interior window by compressing the unit within the window pane and the sliding portion of the window, which bears against the top of the unit. Most units employ an oversized interior portion that bears against the window pane from within the room, preventing the unit from accidentally falling out of the window once installed. Units of this type are generally deployed in warmer months, and then stowed away in a storage area during cooler months or on days when climate control is not necessary and fresh air is desired. This requires a user to lift and remove the assembly from the window and physically transport it to its storage location. Due to the elements of the air conditioner unit and its overall bulkiness, this can be an extremely difficult task for some individuals, including smaller individuals or those lacking the physical ability.

The securing elements of the air conditioner unit are generally not well adapted to be pried upon or used as a support for lifting the assembly. These include window shroud extensions and the window bearing elements of the unit. Aside from its sheer size and bulk, obtaining adequate purchase on the unit so as not to lose the unit through the window or drop the unit on the floor can be a difficult task. Stress on one's hands is a further consideration, wherein there is generally no designed lifting point or hand grip location from which to lift the assembly. Therefore any sharp edges of the unit exterior can bear into a user's hands and cause pain or damage thereto, resulting in a cumbersome job for the user and a risk of dropping the unit during installation or removal periods.

This common handling problem is experienced by nearly all users of window-mounted air conditioner unit during installation, removal and further transportation of the assembly to and from a storage location. Adequate handholds and obtaining sufficient purchase on the assembly requires particular placement of the user's hand an awareness of the unit to prevent grasping locations that may harm the user's hand. It is the goal of the present invention to provide a novel solution for this common problem. There exists a need in the art for an improve means of grip or purchase on a window and wall mounted air conditioner unit, wherein adequate control and handling of the unit is achieved from the interior side of the window during installation and removal, and further while carrying the unit prior to installation or removal. The present invention fulfills this long felt need by providing an attachable or integral set of hand grips on the interior side of a window-mounted air conditioner unit, allowing the user to easily grasp, maneuver and handle the unit during required periods of installation, removal and transport.

2. Description of the Prior Art

Devices have been disclosed in the prior art that relate to appliance lifting means and various grips for air conditioner units. These include devices that have been patented and published in patent application publications. These devices generally relate to a handle along the upper portion of a window-mounted air conditioner or handle grips for an exterior appliance that is lifted from the top. The devices deemed most relevant to the present disclosure are herein described for the purposes of highlighting and differentiating the unique aspects of the present invention, and further highlighting the drawbacks existing in the prior art.

Specifically, U.S. Pat. No. 2,985,092 to Gamache describes a handle for a window mounted appliance, comprising a carrying handle equipped with integrally formed lugs, a handle grip portion extending upwardly from a base portion, and the base portion connecting to the upper portion of the appliance. The base portion further comprises saddle portions for receiving a moveable sash member or the base of a double-hung window. The upwardly extending grip portion acts as a means of gripping the handle and the assembly, as well as a further means to prevent the appliance from falling through the window after the window has been placed against the upper portion thereof and in connect with the saddle portion for the handle. In this way, the tilting motion of the appliance is balanced by the bearing of the handle against the window. The Gamache device, while providing a unique handle that is well adapted for its intended purpose, does not grant the user firm purchase on the assembly prior to the window being withdrawn from the saddle region. The present invention contemplates inwardly facing handles, either integrated into the appliance housing, protruding therefrom or attached thereto, which allows the user to have complete control over the unit as the wind is withdrawn from the top of the appliance when installing or removing the unit.

Further, U.S. Pat. No. 5,317,795 to Bolton discloses a retractable carrying handle for a room air conditioner unit that provides a high strength, safe means of installing, removing and carrying the appliance. The handle is retractable into the air conditioner unit, and comprises a pair of spaced, vertically disposed legs connected to a handle cross member, wherein the legs have an upper and lower body section that are offset from one another and engagable within flanged openings and a stop means. The handle extends from the unit, utilizing its offset body portion and the flange openings to provide a means of carrying the weight of the unit with one hand. The Bolton device describes a handle mechanism that is retractable within the air conditioner housing, but fails to disclose integrated or attachable handles along the forward face of the appliance housing, which allow two-handed grip of the unit for increased purchase and control thereover when handling the unit.

Finally, U.S. Pat. No. 6,044,657 to Nakanuma describes an air conditioner outdoor unit main body having an upper portion with outwardly extending handles that are optimum for carrying and conveying the unit. Handles extend laterally from the upper portion of the unit, wherein the handles include interior spaces within which a user's fingers may be placed as the user gains purchase over the exterior portions of the handle extensions. The handles allow a user to carry an outdoor air conditioning unit using both hands or using a strap that connects through both handles. While providing an improved means of conveyance for an air conditions, the Nakanuma device is limited to outdoor air conditioner units that are much larger than indoor units, and are further placed on a structural foundation rather than fitted within a window pane. The present invention relates to air conditioner handles for handling an indoor, window-mounted unit that requires handling from the unit forward face rather than from above. The unit is fed through an open window and secured by closing the window against the upper portion of the unit. The handles along the forward face allow control and stable purchase over the unit during installation, removal and transport.

The present invention contemplates placement of handles along the forward portion of a window-mounted air conditioner unit, or alternatively the use of attachable strap elements having handles to the unit to facilitate installation, removal and general handling of the unit, which is otherwise cumbersome and difficult. The handles improve the user's grip and purchase on the unit, improving control and stability thereover. In light of the aforementioned prior art, it is submitted that the present invention addresses known drawbacks to window-mounted units and advances the art in the area of air conditioner structures. The design of the present invention fulfills a long felt need that has since been neglected and unaddressed by devices in the prior art, where its structure substantially diverges from design elements in the prior art. Consequently it is clear that there is a need in the art for an improvement to existing window-mounted air conditioner structures. In this regard the instant invention substantially fulfills these needs.

### SUMMARY OF THE INVENTION

In view of the foregoing disadvantages inherent in the known types of window-mounted air conditioner structures now present in the prior art, the present invention provides a new means of handling and grip thereof, wherein the same can be utilized for providing convenience for the user when installing, removing or otherwise handling a window-mounted air conditioner unit.

It is therefore an object of the present invention to provide a new and improved air conditioner grip device that has all of the advantages of the prior art and none of the disadvantages.

It is another object of the present invention to provide an air conditioner grip device that provides improved control and grip over a window-mounted unit, wherein control is granted to a user handling the device from the interior side thereof.

Another object of the present invention is to provide an air conditioner grip device that allows two-handed grip of the interior side of the device, wherein installation, removal and general carrying of the assembly is facilitated.

Yet another object of the present invention is to provide an air conditioner grip device that is attachable to a window-mounted unit, wherein attachment straps span lengthwise or widthwise therearound for establishing a secure support therearound.

A final object of the present invention is to provide an air conditioner grip device that can be designed into the interior side of the unit or alternatively retrofitted onto existing units using an inexpensive and simple set of elements that attach to the unit.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal perspective view of an embodiment of the present invention, wherein handles are attached to the interior side of the air conditioner unit.

FIG. 2 shows a frontal perspective view of an embodiment of the present invention, wherein handles are integrally designed into the interior side of the air conditioner unit.

FIG. 3 shows a frontal perspective view of an embodiment of the present invention, wherein handles are attached to the lateral sides of the air conditioner unit.

FIG. 4 shows a frontal perspective view of an embodiment of the present invention, wherein lengthwise straps are secured to the air conditioner to position handles along the interior side of the unit.

FIG. 5 shows a frontal perspective view of an embodiment of the present invention, wherein widthwise straps are secured to the air conditioner to position handles along the sides of the unit and outside of the window shrouds.

### DETAILED DESCRIPTION OF THE INVENTION

Reference is made herein to the attached drawings. Like reference numerals are used throughout the drawings to depict like or similar elements of the air conditioner grip device. For the purposes of presenting a brief and clear description of the present invention, the preferred embodiment will be discussed as used for improving handling of a window-mounted air conditioner during installation, removal and general transport thereof. The figures are intended for representative purposes only and should not be considered to be limiting in any respect.

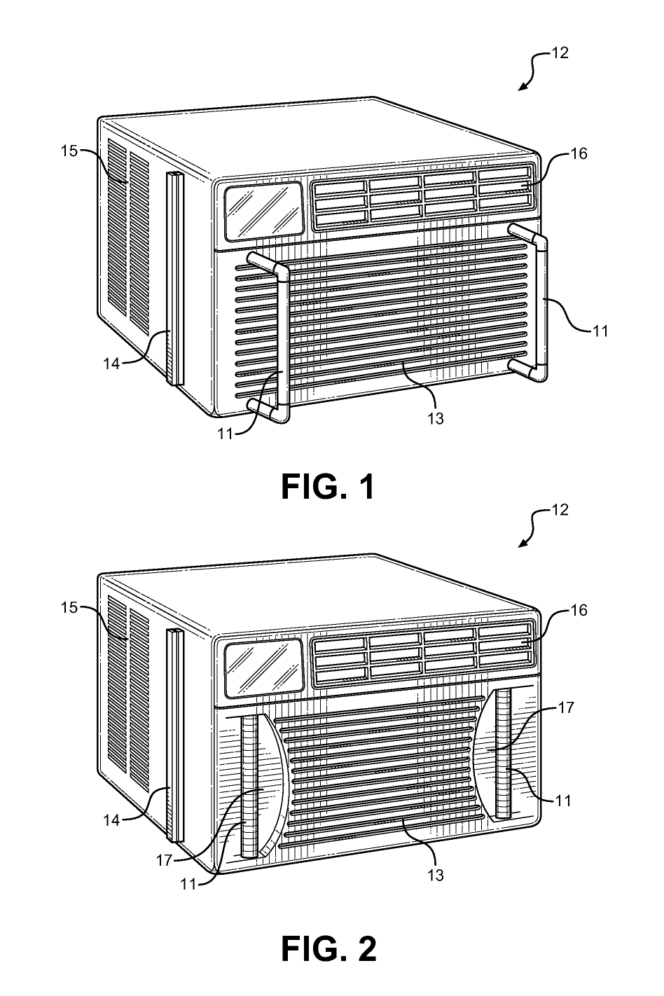

Referring now to FIG. 1, there is shown a frontal perspective view of an embodiment of the present invention, wherein a pair of handle grips 11 are provided along the interior face 13 of a window-mounted air conditioner unit 12. In this embodiment, a first and second vertical hand grip 11 is positioned along the lateral ends of the interior face 13 to provide a user with two hand grip positions that are sufficiently spaced to allow stable handling of the unit when otherwise unsupported or being balanced on a window sill. Each handle 11 comprises a vertical grip portion connected to a first and second attachment member mounted to the air conditioner unit. The attachment members provide an offset for the grip portion to allow adequate spacing for a user's fingers to grip around the grip portion without conflicting with the interior face 13 of the unit. In this embodiment, it is desired that the handle attachment members secure through the frame or similar structural member within the unit 12 via a sufficient attachment means. For example, a screw fastener or nut and bolt fastener may be concentric within the attachment member and connect to structure within the interior of the unit for a secure footing location. This allows the handles to support the significant load of the unit via their four attachment locations. Considerable loads will be reacted at these attachment points, therefore requisite structure is necessary to mount such handles and the unit may be designed with such handle placement locations in mind during assembly.

Using the handles 11, a user is able to lift the unit 12 into an open window, resting the base of the unit 12 against the lower window pane. The user can then free one hand from the grips to close the window onto the unit 12 to secure its position temporarily. The closed window separates the interior side 13 of the unit from the exterior portion 15, while a window shroud 14 is extendable to fill any gaps between the sides of the unit 12 and the window pane. Once fully installed, the handles are released, the window supports the unit and the unit is ready for operation. The handles 11 are provided along the interior portion to allow control during installation and removal, and further are positioned so as not to interfere with the controls and vents 16 of the unit, which would otherwise interfere with normal operation of the air conditioner.

Referring now to FIG. 2, there is shown a frontal perspective view of another embodiment of the air conditioner grip device of the present invention. In this view, a set of hand grips 11 are provided along the ends of the interior face 13 of the unit 12, wherein the handles are positioned within cut-outs 17 along the interior face 13 wherein material is removed to allow gripping of the handles 11 and finger positioning therearound. The handles 11 are aligned with or inset from the interior face 13, which reduces any external features of the unit and allows the user to grip the handles 11 from a position closer to the unit's center of mass. This embodiment is one that is designed into the frame and exterior design of the unit, wherein handles are integrally positioned so as to allow sufficient purchase and handling thereover and without the need for aftermarket or later-installed handles. The handles of this embodiment are utilized exactly as the first embodiment; however their placement closer to the center of mass of the unit 12 reduces the tendency of the unit to tip away from the user due to the moment created by the offset mass of the air conditioner unit.

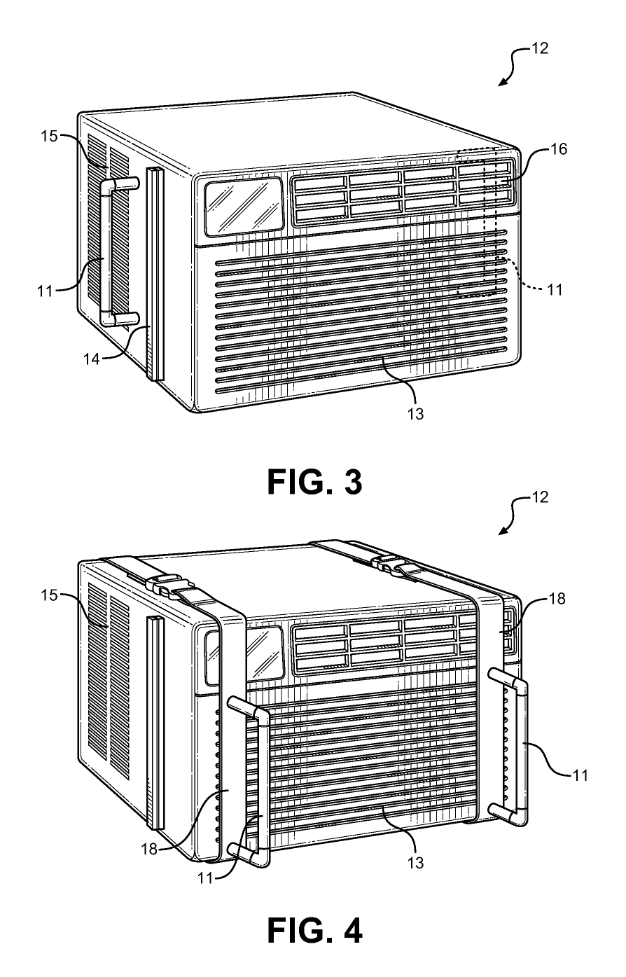

Referring now to FIG. 3, there is shown another embodiment of the present invention, wherein a first and second hand grip 11 is provided along the lateral sides of the air conditioner unit. In this embodiment, the grips 11 are secured to the frame of the unit 12 along its sides, wherein the grips 11 provide outwardly positioned members for which the user to securely hold and position the assembly within an open window. In this embodiment, the extended portion of the handle 11 must be minimized for clearance considerations. Specifically, overly extending handles from the lateral sides of the unit 12 may present a problem when positioning a larger unit 11 into a window, or positioning a standard unit into a smaller window. These handles are designed to provide small clearances for the user's fingers to wrap around the grips and obtain adequate purchase, minimizing overly open handle proportions.

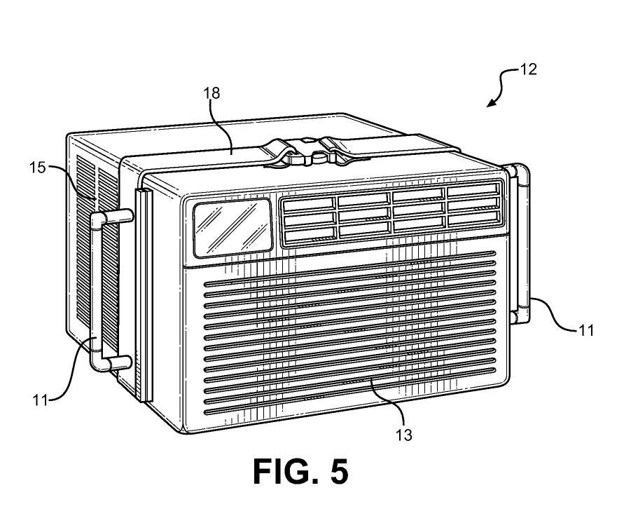

Referring now to FIG. 4, there is shown an embodiment of the present invention wherein a pair of grips 11 is attached to a window-mounted air conditioning unit 12 via adjustable appliance straps, which are adapted to span the outer perimeter of the unit 12 and cinch tightly therealong. The straps 18 allow handles 11 to be retrofitted to existing air conditioning units that are not designed or particularly suited to accept handles through their interior face 13. The straps 18 are elongated members that include a buckle clip along their length, which are utilized to reduce the extended length of the strap while also providing a means to secure the terminal ends thereof together about the exterior of the appliance. In this embodiment, the straps are placed lengthwise along the appliance, wherein the straps cover a portion of the interior face 13 thereof. This positions the handles along the interior side of the appliance for improved handling and install/removal. However, portions of the strap may interfere or cover the control and fan vents of the interior face 13, which may not be desirable. To account for this, and shown now in FIG. 5 for clarity, an embodiment of the straps 18 may be transversely mounted around the appliance such that the strap length spans the width and sides of the unit. This prevents the handles 11 and portions of the strap 18 from blocking the appliance interior face 13, and further places the handles 11 along the sides of the unit 12. In this configuration, a single strap 18 having two handles or two straps transversely mounted may be utilized, whereby the handles 11 are positioned on one side of the window shroud 14, either along an interior portion or exterior end of the unit. In either position and when mounted transversely, the handles are not in contact with the wind pane, and thus may be removable after installation to reduce window clutter. Alternatively they may be kept in place over prolonged periods and utilized when necessary.

In any of the disclosed embodiments of the present invention, it is herein desired to disclose a new and novel means of handling and obtaining secure purchase of a window-mounted air conditioner appliance. These appliances are large and cumbersome, making their installation, removal and general handling a task that is quite difficult for many users. The present invention provides ready handles that reduce the strain and trepidation with regard to handling such large objects and safely placing them within an open window pane.

Existing methods of installing lead to difficulties lifting the unit and setting it into a proper position within the window sill. If an air conditioner is positioned improperly and not securely held by the window, the air conditioner may fall through the window, leading to damaged property and possible injury to those below. Additionally, because of the bare sides and sharp features of typical window-mounted air conditioners, individuals may have difficulty obtaining a secure handle on the unit if it begins to fall through the open window during installation or removal. The embodiments of the present invention offer a flexible solution to this common problem, wherein handles along the interior face of the unit provide secure grip of the unit's weight, while existing units may be retrofitted with attachable handles that secure therearound using securing straps. These durable handles provide secure grip locations for two-handed lifting and support, which individuals may utilize when moving these heavy appliances and stably positioning the same within open windows.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An appliance grip device, comprising:
a window-mounted air conditioner unit having an exterior portion and an interior face;
a first and second hand grip handles connecting to said interior face, said handles comprising a vertical grip region for two-handed support of said air conditioner unit.

2) The device of claim 1, wherein said handles further comprise a first and second attachment member perpendicularly mounted to said vertical grip region terminal ends, said attachment members connecting to said air conditioner front face and offsetting said vertical grip region therefrom.

3) The device of claim 2, wherein said handle attachment members fasten through said interior face to a frame member of said air conditioner unit.

4) The device of claim 1, wherein said vertical grip region of said handles are positioned within the interior of cut-outs along said air conditioner interior face, wherein said cut-out provides sufficient space to grasp said vertical grip regions

5) An appliance grip device, comprising:
a window-mounted air conditioner unit having an exterior portion, lateral sides and an interior face;
a first and second hand grip handles connecting to said lateral sides, said handles comprising a vertical grip region for two-handed support of said air conditioner unit.

6) The device of claim 5, wherein said handles further comprise a first and second attachment member perpendicularly mounted to said vertical grip region terminal ends, said attachment members connecting to said air conditioner lateral sides and offsetting said vertical grip region therefrom.

7) The device of claim 6, wherein said handle attachment members fasten through said lateral sides to a frame member of said air conditioner unit.

8) An appliance grip device, comprising:
at least one elongated strap member having a first and second terminal end;
said terminal ends being removably connectable and having a cinching means for reducing said elongated strap length;
at least one hand grip handle attached along said strap length;
said strap adapted to secure around the exterior of an appliance for secure purchase thereof.

9) The device of claim 8, wherein a first and second strap member having a single hand grip are adapted to be positioned lengthwise around a window-mounted air conditioner unit for supporting said unit from said hand grips along said unit interior face.

10) The device of claim 8, wherein a first and second strap member having a single hand grip are adapted to be positioned transversely around a window-mounted air conditioner unit for supporting said unit from hand grips along said unit sidewalls.

11) The device of claim 8, wherein a first strap member having a first and second hand grip are adapted to be positioned transversely around a window-mounted air conditioner unit for supporting said unit from said hand grips along said unit sidewalls.
